(19) United States
(12) Patent Application Publication
(10) Pub. No.: US 2025/0264154 A1
(43) Pub. Date: Aug. 21, 2025

(54) TRANSMISSION GEARBOX SEALING ASSEMBLY

(71) Applicant: Dana Heavy Vehicle Systems Group, LLC, Maumee, OH (US)

(72) Inventors: Nicholas W. LAFORCE, Whitehouse, OH (US); Bradley SPITLER, Whitehouse, OH (US)

(21) Appl. No.: 18/581,966

(22) Filed: Feb. 20, 2024

(51) Int. Cl. F16H 57/029; G01P 1/02; G01P 3/44

(52) U.S. Cl. CPC F16H 57/029; G01P 1/026; G01P 3/44

(57) ABSTRACT

Systems are herein provided for using a tone wheel of a speed sensing system as a primary sealing interface for a transmission gearbox scaling assembly. The scaling assembly, in one examples, comprises the tone wheel positioned about an output shaft and in contact with a primary scaling lip of a lip seal, thereby acting as the primary sealing surface.

### TECHNICAL FIELD

Embodiments of the subject matter disclosed herein relate to transmission gearbox scaling solutions, and more particularly to using a Hall effect sensor tone wheel as a primary scaling interface in a transmission gearbox scaling assembly.

### BACKGROUND AND SUMMARY

Vehicles typically include a transmission with a gearbox to transit rotational power from an engine or electric motor to an axle assembly, a differential assembly, and other downstream components. The differential assembly regulates drive torque between wheel axle shafts, thereby permitting the shafts to rotate at different velocities such as when one of the drive wheels is slipping or when the vehicle is turning. Speed sensor assemblies for vehicles are used to monitor the rotational speed of and/or towards the wheels for various purposes such as for implementing antilock or automatic braking system (ABS), traction control systems, and/or as input to an engine or transmission controller. A speed sensor can be employed to sense the rotational speed of a wheel, shaft, or other component.

For example, a speed sensor can be employed to sense the rotational speed of an output shaft of the transmission. Traditionally, this speed sensor includes a tone wheel with a Hall effect sensor, the tone wheel being located in the oil sump of the gearbox. The tone wheel contains slots or teeth that trigger the Hall effect sensor when the tone wheel rotates. These slots can cause windage to the gearbox that results in power loss and oil foaming. Further, encompassing the tone wheel in oil demands a greater volume of oil to fill the gearbox sufficiently.

In a gearbox, a primary oil sealing interface is typically associated with rotating components, such as input and output shaft and reduces oil leakage from the gearbox and debris and other contaminants from entering the gearbox. Traditional sealing solutions use a primary radial lip seal on a hardened steel shaft designed to create a barrier between internal components of the gearbox and the external environment. In such examples, to avoid contaminating this primary sealing surface, a stamped steel deflector is used to either contact an axial auxiliary seal lip or create a labyrinth that makes it more difficult for contamination or water to contact the primary sealing surface. Current solutions to the above mentioned issues with positioning tone wheels in the oil sump include moving the tone wheel outside of the oil sump. However, doing so demands a non-traditional approach to sealing the transmission gearbox and protecting the tone wheel and Hall effect sensor from degradation, which demands an unfavorable design for the gearbox.

The inventors herein have recognized the aforementioned issues and developed a system to at least partially address them. In one example, a tone wheel may be incorporated as part of the sealing solution for the transmission. In a first embodiment, the tone wheel may be a single piece that is used as both the primary sealing surface and accommodates an auxiliary axial seal or labyrinth. The tone wheel interfaces with a primary sealing lip of a lip seal to be the primary sealing interface. With the tone wheel and its teeth out of the oil, windage may be reduced and the amount of oil demanded in the sump to sufficiently pump throughout the transmission may be reduced. Additional embodiments as herein described include a two piece tone wheel, a tone wheel with a labyrinth style seal lip, and a tone wheel with an extension dust shield feature that replaces a yoke deflector or cover. The various embodiments may be incorporated in various combinations, in some examples. In any of the aforementioned embodiments as herein presented, incorporating the tone wheel as part of the sealing solution for the gearbox reduces the number of components needed to seal the gearbox, therefore reducing manufacturing time and expenditure.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows an example of a vehicle drive train.

FIG. 2 shows a transmission gearbox sealing according to a first embodiment of the present disclosure.

FIG. 3 shows a transmission gearbox sealing according to a second embodiment of the present disclosure.

FIG. 4 shows a transmission gearbox sealing according to a third embodiment of the present disclosure.

FIG. 5 shows a transmission gearbox sealing according to a fourth embodiment of the present disclosure.

### DETAILED DESCRIPTION

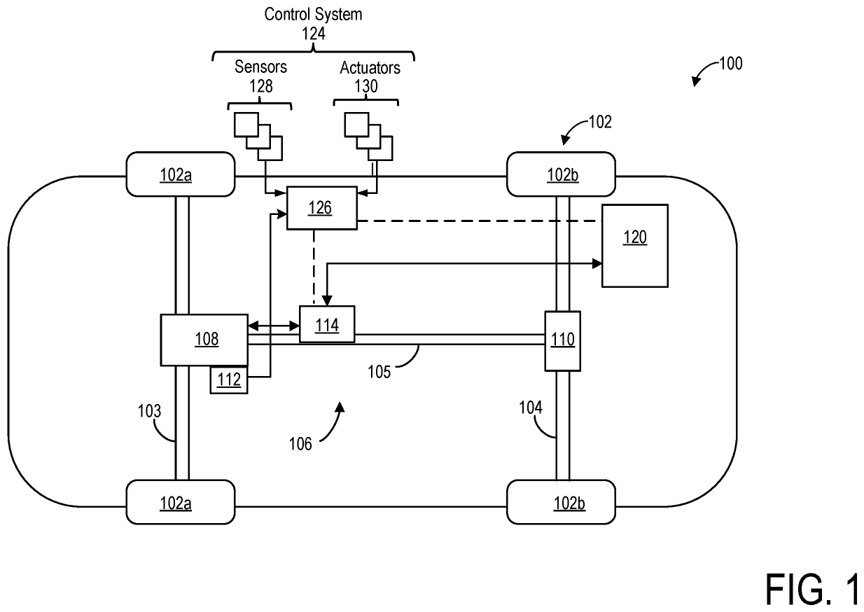

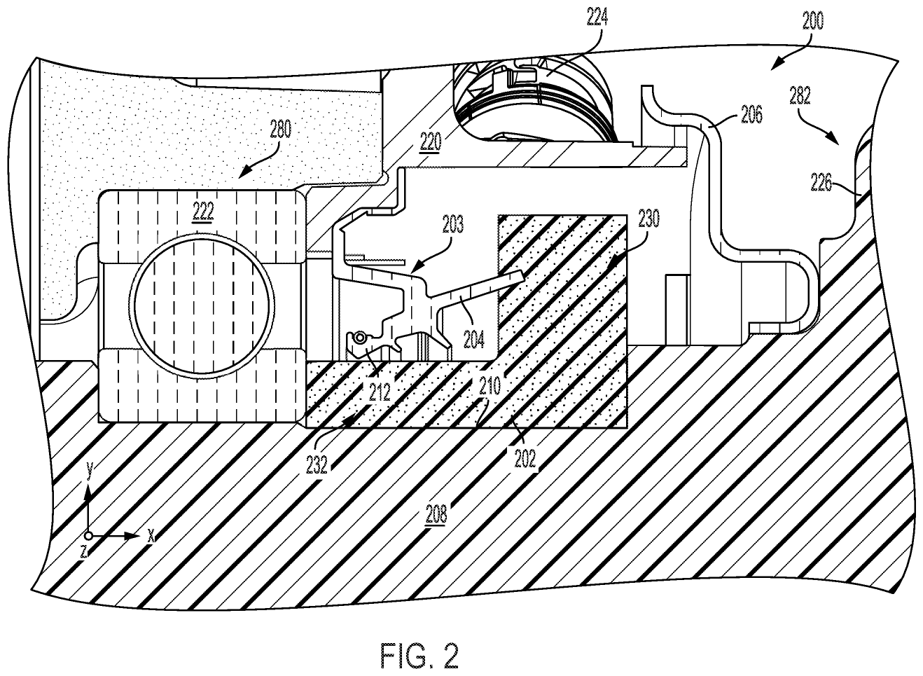

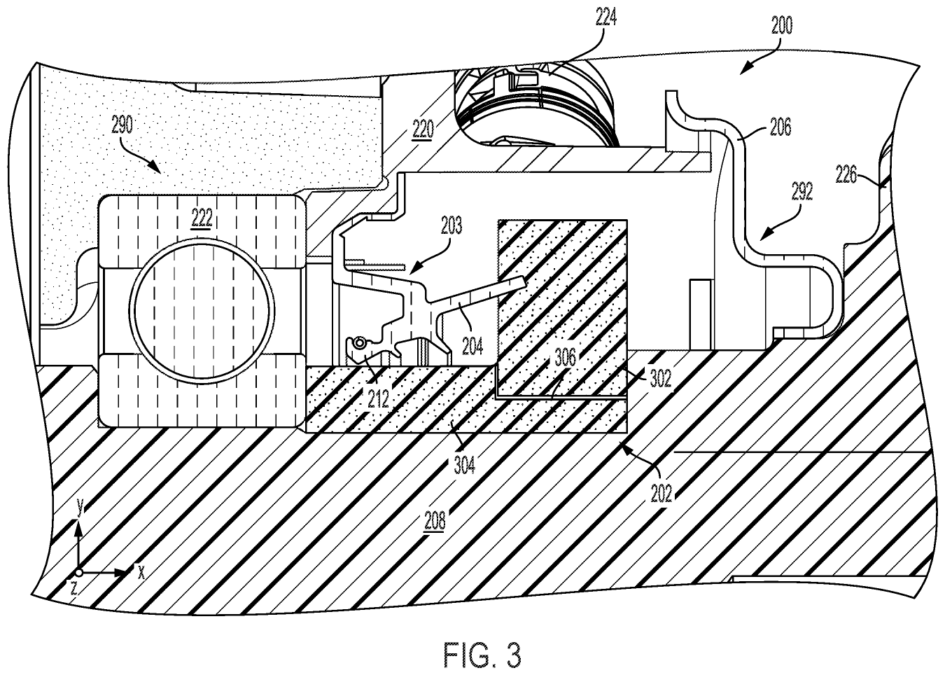

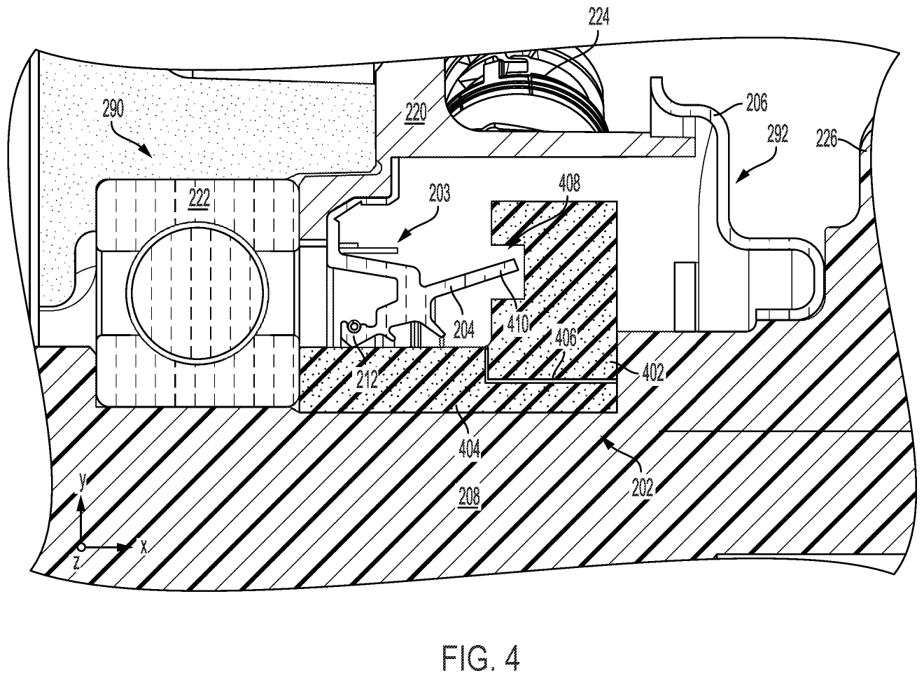

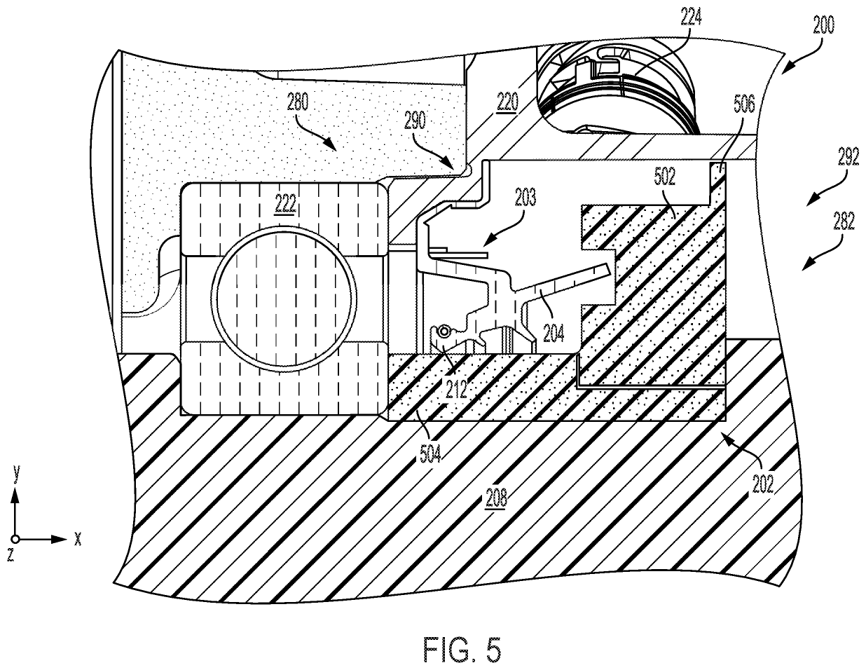

The following description relates to systems and methods for using a Hall Effect sensor tone wheel as a sealing and load carrying interface. An exemplary vehicle system, as shown in FIG. 1, may comprise a transmission with a gearbox and a tone wheel incorporated therein for speed sensing. A first embodiment of a transmission gearbox sealing assembly with a single piece tone wheel as a primary sealing interface is shown in FIG. 2. A second embodiment of a transmission gearbox sealing assembly with a two-piece tone wheel is shown in FIG. 3. A third embodiment of a transmission gearbox sealing assembly with a tone wheel incorporating a cut out to form a labyrinth style sealing solution is shown in FIG. 4. A fourth embodiment of a transmission gearbox sealing assembly with a tone wheel incorporating a dust shield element is shown in FIG. 5.

Turning now to FIG. 1, a schematic representation of a vehicle 100 is depicted. It will be appreciated that vehicle 100 is shown in FIG. 1 or illustrative purposes and is a non-limiting example of a how a vehicle may be configured. Other examples may include variations in arrangements and positioning of vehicle components depicted in FIG. 1, as well as additional components not shown in FIG. 1 for brevity. Vehicle 100 may be an internal combustion engine (ICE) vehicle, a hybrid electric vehicle (HEV), or an all-electric vehicle (EV). Vehicle 100 includes wheels 102, e.g., front wheels 102a and rear wheels 102b, with the front wheels 102a coupled by a front axle 103 and the rear wheels 102b coupled by a rear axle 104. As shown in FIG. 1, the vehicle 100 may be configured with rear-wheel drive but other examples include vehicles with front-wheel drive, four-wheel drive, or all-wheel drive.

A drive train 106 of vehicle 100 may include a transmission 108 (e.g., a gear box, gear train, etc.) configured to receive torque input from a rotating source and output torque to a drive shaft 105. When configured as an EV, an electric machine 114 may be the rotating source. In some examples, more than one electric machine 114 may provide rotational power to the transmission 108. When configured as an HEV, the vehicle may include an engine as well as the electric machine 114. When configured as an ICE, the vehicle may include an engine instead of the electric machine 114. In some examples, the electric machine 114 may be a motor/generator, with a capacity to convert electrical energy into mechanical energy and vice versa. As such, the electric machine 114 may be electrically coupled to a traction battery 120 of vehicle 100 to both draw power from the traction battery 120 and generate electrical energy to be stored at the traction battery 120.

The drive shaft 105 may extend between the transmission 108 and a differential 110 and may be engaged by the transmission 108 to output torque. The output torque may be moderated based on selective adjustments to gear engagement at the transmission 108 to accommodate desired vehicle operation. The differential 110 is arranged at a central region of the rear axle 104, and rotation of the drive shaft 105 may drive rotation of various gears, such as side gears, pinion gears, etc. of the differential 110, which is transferred to rotation of the rear axle 104.

Vehicle 100 may further include a control system 124, including a controller 126, sensors 128, and actuators 130. Controller 126 may be a microcomputer, including elements such as a microprocessor unit, input/output ports, an electronic storage medium for executable programs and calibration values, e.g., a read-only memory chip, random access memory, keep alive memory, and a data bus. In one example, controller 126 may be a powertrain control module (PCM).

Controller 126 may receive various signals from sensors 128 coupled to various regions of vehicle 100. For example, the sensors 128 may include position sensors coupled to the transmission 108 and the differential 110, sensor for monitoring motor and shaft speed, temperature, air mass flow, etc., sensors coupled to the traction battery 120 for measuring a battery state of charge and temperature, and sensors coupled to the electric machine for monitoring a status of the electric machine 114. Upon receiving the signals from the various sensors 128 of FIG. 1, controller 126 processes the received signals, and employs various actuators 130 of vehicle 100 to adjust engine and drive train operations based on the received signals as well as instructions stored at a memory of controller 126.

As noted, the various sensors 128 may comprise a sensor for monitoring motor, wheel, and shaft speed, such as vehicle speed sensor system 112. In some examples, the vehicle speed sensor system 112 may sense wheel speed, motor input speed, transmission output speed, or the like. The vehicle speed sensor system 112 may comprise a Hall effect sensor and a tone wheel (e.g., a tone ring). The tone wheel may be a toothed or slotted disk or ring wherein the teeth are spaced apart evenly. In some examples, the tone wheel may be magnetized or comprise magnetized components, for example the teeth of the tone wheel may have magnetic properties or affect a magnetic fuel such as if constructed of a ferromagnetic material. The tone wheel may be positioned on a rotating component, for example a shaft, and as such the tone wheel may also rotate. The Hall effect sensor may be configured to produce a voltage proportional to the strength of the magnetic field to which it is exposed. The Hall effect sensor may be positioned near the rotating tone wheel such that the sensor may sense changes in the magnetic field of the teeth of the tone wheel as it rotates. An alternating pattern of magnetic poles on the tone wheel may induce corresponding changes in the magnetic field strength detected by the Hall effect sensor. The voltage signal generated by the Hall effect sensor may be processed by the controller 126 in order to determine speed, rotational direction, position of the rotating shaft on which the tone wheel is positioned.

In some examples, the tone wheel of the vehicle speed sensor system 112 may be positioned in the oil sump of the gearbox of the transmission (e.g., transmission 108). The slots or teeth of the tone wheel may thus cause windage in the gearbox resulting in power loss and oil foaming. The windage generated may be greater due to the surrounding oil and thus the accuracy of the associated Hall effect sensor may be reduced. Further, a greater volume of oil in the sump may be demanded in order to fil the gear box sufficiently when the tone wheel is positioned in the sump. Other approaches include positioning the tone wheel outside the sump, however the sealing approaches are affected.

Traditional transmission gearbox sealing solutions may use a primary radial lip seal on a hardened steel shaft. To avoid contaminating this primary sealing surface, a stamped deflector may be used to either contact an axial auxiliary seal lip or create a labyrinth that makes it more difficult for contamination or water to contact the primary sealing surface. However, nontraditional sealing solutions may demand an unfavorable design, increasing the complexity of the system. The vehicle speed sensor system as herein disclosed incorporates the tone wheel as part of the sealing solution, thereby allowing for a more favorable and less complex design for manufacturing, as well as maintaining the benefits of decreased windage, lower demanded volume of oil, and decreased degradation to the tone wheel from exposure to oil and contaminants provided by positioning the tone wheel outside the sump.

Turning now to FIG. 2, a transmission gearbox sealing assembly 200 according to a first embodiment of the present disclosure is shown. The transmission gearbox sealing assembly 200, in any of the embodiments herein presented, may be incorporated into a vehicle system, similar to vehicle 100 as described above. For example, the transmission gearbox sealing assembly 200 may be incorporated near an output of the transmission, such as an output shaft and an end yoke. The transmission gearbox sealing assembly 200 may seal internal component of the transmission, such as shafts, gears, clutches, and the like, from an environment external to the gearbox.

The transmission gearbox sealing assembly 200 may comprise a tone wheel 202 and a lip seal 203. The lip seal 203 may comprise a primary scaling lip 212 and an auxiliary lip seal 204. While not specifically shown in the figures, the tone wheel 202, as previously described, may comprise a plurality of teeth or slots. The tone wheel 202 may be positioned about a shaft 208, for example an output shaft, in some examples, such that the tone wheel 202 rotates with the shaft 208. The output shaft, responsible for transmitting power through the end yoke to downstream components, such as driveshafts, differentials, and the like, may rotate at a given speed. A Hall effect sensor 224 may be positioned near the tone wheel 202 and may be configured to sense the speed of the output shaft based on the rotation of the teeth or slots of the tone wheel 202, as described above.

The tone wheel 202 may be positioned about the shaft 208 such that the tone wheel 202, in contact with the primary sealing lip 212 of the lip seal 203, is the primary sealing interface for the oil seal of the transmission gearbox. The tone wheel 202, as the primary sealing interface thereby mitigates oil leakage from an interior 280 of the gearbox and reduces debris from an exterior 282 from entering the gearbox. As such, the tone wheel 202 may comprise a main body 230 that comprises the teeth or slots and is oriented perpendicular to the axis of rotation of the shaft 208 and a sealing body 232 that circumferentially surrounds a portion of the shaft 208 and is coaxial with the shaft 208. The main body 230 may be oriented towards a first side 290 of the sealing assembly 200 which faces towards the exterior 282. The sealing body 232 may extend towards a second side 292 of the scaling assembly 200, which faces towards the interior 280. In the first embodiment herein described, the primary sealing lip 212 may contact the scaling body 232 and the auxiliary lip seal 204 may contact the main body 230.

The tone wheel 202, specifically the sealing body 232 of the tone wheel 202, and the shaft 208 may be mounted together with a spline 210 to maintain the relative positions thereof. In some examples, the transmission gearbox sealing assembly 200 may include an o-ring static seal positioned at an exterior edge of the tone wheel 202 to mitigate any spline seepage. The o-ring static seal may be positioned at the first side 290 of the spline 210, at the second side 292 of the spline 210, or within the spline 210, in various examples. In the first embodiment as shown in FIG. 2, the auxiliary lip seal 204 may be positioned in contact with the tone wheel 202. The auxiliary lip seal 204 may provide an additional barrier, helping to further reduce oil leakage and mitigate debris entering the gearbox.

A yoke deflector or cover 206 may be positioned external a housing 220 of the transmission. The cover 206 may be coupled to or otherwise formed as part of the same assembly with a yoke 226. The yoke 226 may be an example of an output interface, in some examples other types of output interfaces may be used without departing from the scope of this disclosure, and may transmit rotational torque from the shaft 208 to the downstream components. The cover 206 may deflect or redirect fluid, particles, or the like away from the shaft 208, the yoke 226, the tone wheel, or other components of the transmission and/or transmission sealing assembly.

In some examples, the tone wheel 202 may be positioned about the shaft 208 a distance away from the cover 206. The distance between the tone wheel 202 and the cover and yoke reduces complexity of the system as the yoke/cover may be manufactured separate from the tone wheel without needed to design and manufacture a yoke that specifically interfaces with the tone wheel. In other examples, the tone wheel 202 may be positioned to contact the yoke 226, thus providing an extra layer of sealing to reduce leakage of oil.

Because the tone wheel 202 is positioned to act as the primary sealing surface, the teeth of the tone wheel 202 may be out of the oil that is in both the oil sump and the interior of the gearbox. With the tone wheel 202 out of the oil, windage may be reduced and therefore accuracy of the reading of the Hall effect sensor may be increased.

Additionally, the tone wheel 202 may be configured for carrying the clamp force of the pinion nut to bearing 222. Bearing 222 may facilitate and support rotation of the shaft 208 inside the gearbox. In some examples, the tone wheel 202 may be clamped between the yoke 226 and the bearing 222. The pinion nut (not shown) may provide the clamping force and the tone wheel 202 may thus carry the clamping force. In this way, the tone wheel 202 may be configured for load carrying of the system.

Turning to FIG. 3, a second embodiment of the transmission gearbox sealing assembly 200 is shown. In the second embodiment, the tone wheel 202 may be a two-piece component. As such, the tone wheel 202 may comprise a first section 302 and a second section 304. The first section 302 may contact the auxiliary lip seal 204 while the second section 304 may be positioned perpendicular thereto and may contact the primary sealing lip 212. The first section 302 may comprise the teeth (or slots) of the tone wheel 202 and may be positioned perpendicular to the axis of rotation of the shaft 208, similar to the main body 230 described with respect to the first embodiment. The second section 304 may comprise a sealing sleeve that is circumferential about and coaxial with the shaft 208. In some examples, the sealing sleeve may be formed of a heat treated steel. The first section 302 may be pressed onto the second section 304 (e.g., the sealing sleeve) at an interface 306. The second section 304 may be affixed in a variety of ways including press force, glue, keyway, welding, or the like.

The two piece tone wheel design as described herein with respect to the second embodiment may allow for different materials for the pieces. For example, the first section 302 may be formed of a hardened steel material while the second section 304 may be a powdered metal material. In this way, the two-piece design may be more cost effective for manufacturing.

Turning now to FIG. 4, a third embodiment of the transmission gearbox sealing assembly 200 is shown. In the third embodiment, the tone wheel 202 is configured to accommodate a labyrinth style seal for the auxiliary lip seal 204. The third embodiment as shown in FIG. 4 also includes a two piece tone wheel, similar to as presented in the second embodiment, though it should be understood that the third embodiment as herein described may be implemented with a single piece tone wheel.

The tone wheel 202 of the transmission gearbox scaling assembly 200 according to the third embodiment, when the tone wheel 202 is a two-piece tone wheel, includes a first section 402 and a second section 404 formed together at an interface 406, similar to as described with respect to the third embodiment of FIG. 3. The first section 402 may comprise a main body of the tone wheel 202, including the teeth or slots thereof. The second section 404 may comprise the scaling sleeve and may be positioned around and mounted via a spline to the shaft 208. The first section 402 may comprise a cutout 408. The cutout 408 may align with a tooth 410 of the auxiliary lip seal 204. The tooth 410 of the auxiliary lip seal 204 may extend towards the tone wheel 202 without contacting the tone wheel 202 due to the cutout 408.

The cutout 408 and the lack of contact between the auxiliary lip seal 204 may form a labyrinth style sealing solution. The labyrinth style sealing solution, via its maze-like structure with its series of paths, may hinder passage of fluids. The circuitous path that the cutout 408 creates in between the tone wheel 202, which may be the primary sealing interface as discussed, and the auxiliary lip seal 204 may reduce fluid leakage out of the gearbox. It may also serve as a barrier against external contaminants such as dust, dirt, and moisture as the convoluted pathway makes it challenging for the contaminants to reach the internal space of the gearbox.

In some examples, the labyrinth style sealing of the auxiliary lip seal 204 may provide for a more dynamic sealing in conditions in which the auxiliary lip seal 204 is a stationary component and the tone wheel 202 is rotating with the shaft 208. Further, the labyrinth style seal allows for reduced friction, reduced heat generation, lower primary lip sealing temperatures due to the allowance of venting, and reduced wear on the lip seal 203. The third embodiment as herein described may be utilized so long as the labyrinth can effectively prevent particles like dirt and water from getting to the primary sealing lip 212.

Turning now to FIG. 5, a fourth embodiment of the transmission gearbox scaling assembly 200 is shown. In the fourth embodiment, the tone wheel 202 is configured as an exterior cover by way of inclusion of a dust shield component. The fourth embodiment as shown in FIG. 5 also includes a labyrinth style seal and two piece tone wheel similar to as is presented in the second and third embodiments in FIGS. 3 and 4, though it should be understood that the fourth embodiment as herein disclosed may also be implemented in examples where the auxiliary lip seal contacts the tone wheel, where the tone wheel is a single piece, or combinations thereof. In this way, the various embodiments herein presented may be implemented in various combinations depending on end use application and other factors.

The transmission gearbox sealing assembly 200 as shown may include the tone wheel 202, including in examples in which the tone wheel 202 is a two-piece tone wheel, a first section 502 and a second section 504. As previously discussed, the first section 502 may be a main body of the tone wheel that includes the teeth or slots and the second section 504 may be a sealing sleeve that is positioned around the shaft 208. The tone wheel 202 may further comprise an extension 506. The extension 506 may extend vertically away from the main body of the tone wheel 202 (e.g., the first section 502 in examples in which the tone wheel is a two-piece component). The extension 506 may be positioned more towards the first side 290 than the second side 292, thereby facing the exterior 282 of the gearbox. In some examples, the extension 506 may protrude vertically so as to be in face sharing contact with the housing 220 of the gearbox. In other examples, the extension 506 may protrude vertically to nearly contact the housing 220. The extension 506 as thus described may be a dust shield feature integrated into and formed as part of the tone wheel 202. With the extension 506, the second side 292 of the tone wheel 202 may be a substantially flat surface.

In the fourth embodiment, the dust shield (e.g., the extension 506) of the tone wheel 202 replaces the cover of the yoke and acts to further reduce leakage of fluid out of the gearbox and mitigate entry of debris into the gearbox. The extension 506 may be formed as part of the tone wheel 202 during manufacture. Because the extension 506 replaces the yoke deflector (e.g., cover) of the first, second, and third embodiments, the number of components manufactured and assembled may be reduced, thereby reducing manufacturing and assembling time.

Thus, the technical effect of the systems described above is that windage and degradation to the tone wheel may be reduced by moving the tone wheel out of the oil sump. Further, by integrating the tone wheel as the primary sealing interface and in some embodiments including a dust shield, number of components demanded for manufacture may be reduced. The various embodiments herein presented allow for flexibility of end use application.

The disclosure also provides support for a transmission gearbox sealing assembly, comprising: a tone wheel, and a lip seal comprising a primary scaling lip and an auxiliary lip seal, wherein the tone wheel interfaces with the primary sealing lip and is configured as a primary sealing surface for the transmission gearbox. In a first example of the system, the tone wheel comprises a dust shield. In a second example of the system, optionally including the first example, the tone wheel is positioned circumferentially about an output shaft and configured to rotate with the output shaft. In a third example of the system, optionally including one or both of the first and second examples, the tone wheel is a two-piece tone wheel, comprising a first section and a second section, the second section interfacing with the primary sealing lip. In a fourth example of the system, optionally including one or more or each of the first through third examples, the first section of the two-piece tone wheel is a main body of the tone wheel comprising a plurality of teeth and the second section is a sealing sleeve. In a fifth example of the system, optionally including one or more or each of the first through fourth examples, the sealing sleeve is positioned circumferentially around an output shaft. In a sixth example of the system, optionally including one or more or each of the first through fifth examples, the system further comprises: an o-ring seal positioned one of before, after, and at a spline interface between the tone wheel and an output shaft.

The disclosure also provides support for a tone wheel, comprising: a main body, and a sealing body, wherein the tone wheel is positioned circumferentially about an output shaft and interfaces with a primary sealing lip of a lip seal, the tone wheel configured as a primary sealing interface for a gearbox in which the output shaft is incorporated. In a first example of the system, the system further comprises: a dust shield, wherein the dust shield faces an exterior of the gearbox. In a second example of the system, optionally including the first example, the main body and the sealing body are separate pieces. In a third example of the system, optionally including one or both of the first and second examples, the main body and the sealing body are part of the same piece. In a fourth example of the system, optionally including one or more or each of the first through third examples, the system further comprises: a cutout configured to align with an auxiliary lip seal of the lip seal to form a labyrinth style sealing surface for the gearbox.

The disclosure also provides support for a method for transmission gearbox sealing, comprising: positioning a tone wheel circumferentially about a shaft and in contact with a lip seal such that the tone wheel is a primary sealing surface for the transmission gearbox. In a first example of the method, the tone wheel comprises a cutout configured to form a labyrinth style sealing solution. In a second example of the method, optionally including the first example, the tone wheel is positioned in contact with a primary sealing lip of the lip seal. In a third example of the method, optionally including one or both of the first and second examples, the tone wheel is further positioned in contact with an auxiliary lip seal of the lip seal. In a fourth example of the method, optionally including one or more or each of the first through third examples, the tone wheel is further positioned not in contact with an auxiliary lip seal of the lip seal. In a fifth example of the method, optionally including one or more or each of the first through fourth examples, the tone wheel comprises a first section and a second section, the first and second sections formed as separate pieces. In a sixth example of the method, optionally including one or more or each of the first through fifth examples, the first section of the tone wheel is positioned in contact with an auxiliary lip seal of the lip seal and the second section is positioned in contact with the primary sealing lip. In a seventh example of the method, optionally including one or more or each of the first through sixth examples, the first section comprises a dust shield.

FIGS. 2-5 example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A transmission gearbox sealing assembly, comprising:
a tone wheel; and
a lip seal comprising a primary sealing lip and an auxiliary lip seal, wherein the tone wheel interfaces with the primary sealing lip and is configured as a primary sealing surface for the transmission gearbox.

2. The transmission gearbox sealing assembly of claim 1, wherein the tone wheel comprises a dust shield.

3. The transmission gearbox sealing assembly of claim 1, wherein the tone wheel is positioned circumferentially about an output shaft and configured to rotate with the output shaft.

4. The transmission gearbox sealing assembly of claim 1, wherein the tone wheel is a two-piece tone wheel, comprising a first section and a second section, the second section interfacing with the primary sealing lip.

5. The transmission gearbox sealing assembly of claim 4, wherein the first section of the two-piece tone wheel is a main body of the tone wheel comprising a plurality of teeth and the second section is a sealing sleeve.

6. The transmission gearbox sealing assembly of claim 5, wherein the sealing sleeve is positioned circumferentially around an output shaft.

7. The transmission gearbox sealing assembly of claim 1, further comprising an o-ring seal positioned one of before, after, and at a spline interface between the tone wheel and an output shaft.

8. A tone wheel, comprising:
a main body; and
a sealing body, wherein the tone wheel is positioned circumferentially about an output shaft and interfaces with a primary sealing lip of a lip seal, the tone wheel configured as a primary sealing interface for a gearbox in which the output shaft is incorporated.

9. The tone wheel of claim 8, further comprising a dust shield, wherein the dust shield faces an exterior of the gearbox.

10. The tone wheel of claim 8, wherein the main body and the sealing body are separate pieces.

11. The tone wheel of claim 8, wherein the main body and the sealing body are part of the same piece.

12. The tone wheel of claim 8, further comprising a cutout configured to align with an auxiliary lip seal of the lip seal to form a labyrinth style sealing surface for the gearbox.

13. A method for transmission gearbox sealing, comprising:
positioning a tone wheel circumferentially about a shaft and in contact with a lip seal such that the tone wheel is a primary sealing surface for the transmission gearbox.

14. The method of claim 13, wherein the tone wheel comprises a cutout configured to form a labyrinth style sealing solution.

15. The method of claim 13, wherein the tone wheel is positioned in contact with a primary sealing lip of the lip seal.

16. The method of claim 15, wherein the tone wheel is further positioned in contact with an auxiliary lip seal of the lip seal.

17. The method of claim 15, wherein the tone wheel is further positioned not in contact with an auxiliary lip seal of the lip seal.

18. The method of claim 15, wherein the tone wheel comprises a first section and a second section, the first and second sections formed as separate pieces.

19. The method of claim 18, wherein the first section of the tone wheel is positioned in contact with an auxiliary lip seal of the lip seal and the second section is positioned in contact with the primary sealing lip.

20. The method of claim 18, wherein the first section comprises a dust shield.
